(19) United States
(12) Patent Application Publication
(10) Pub. No.: US 2011/0315679 A1
(43) Pub. Date: Dec. 29, 2011

(54) Apparatus of a combined ice cream cup and a connecting means, and method of connecting ice cream cups

(76) Inventor: Eran Sasson, Azor (IL)

(21) Appl. No.: 12/824,269

(22) Filed: Jun. 28, 2010

(51) Int. Cl. B65D 21/028; F28F 7/00; B23P 11/00

(52) U.S. Cl. 220/23.4; 29/428; 165/185

(57) ABSTRACT

The present invention relates to an apparatus of an ice cream cup embodying a hollow portion of a cup suitable to accommodate an ice cream material which has a connecting mean that enables to connect more cups of the same apparatus to the same cup, such cup enabling inserted and connecting or disconnecting one cup to at least one more cup, and a method that enable the connecting of multiple ice cream cups to each other, wherein, the present invention apparatus and method enabling to use separate different flavor of ice cream to each and every cup, instead of stacking ice cream balls on top each other. More particularly, the present invention uses a special made handle to circumvent direct heat transfer through ice cream grasping by hands. This interconnecting ice cream cup system, with separated cups containing either the same or different flavors of ice cream, is formed in a technique that designated either as a handle or a cup, to form as a connector that fitted with another cup apparatus of the present invention, enabling the user to hold in one hand more than multiple cups of ice cream as in the present invention to allow tasting different flavors of ice cream and reduce ice cream melting through heat transfer by hands.

### FIELD of the INVENTION

This invention relates generally to an apparatus of a combined ice cream cup and cup to other connecting means, and method wherein the cup of the present invention includes a ribs, which can be another element such as a handle, at the cup outer side enabling a better thermal condition, separation between the hand user grip and heat and the ice-cream temperature at the inner hollow zone, and preventing the ice-cream from melting.

### BACKGROUND OF THE INVENTION

It is well known to the one skilled in the art, that handling with eating and holding ice cream, frozen yogurt and the like have been problematic to the customer that intended to consume such product, and for that reason and more it was uncomfortable to the sellers too, wherein, such problems associated with handling cups and existing ice cream cones are for example the lack of opportunity to share one or multiple flavors of ice cream that includes, for example more than one scoop of ice cream with another partner, without mixings of the different flavors of ice cream. Existing solutions is incapable of serving each individual scoop of ice cream (i.e., an ice cream ball) independently from even another ice cream ball in a structure of cup or cone fitted to the customer needs.

Various attempts have been made to provide solutions for such needs. For example, solutions such as ice cream cone trays shown in U.S. Pat. Nos. 4,291,805 and D261,466 comprising a tray having a plurality of conical sockets which extend downwardly from the trays with the vertex of each conical socket positioned below its respective open base.

U.S. Pat. No. D362,947 illustrates a support having a single conical socket also with the vertex of the conical socket positioned below its open base. This approach presents a problem in that the sockets are limited to use with conical shaped ice cream cones and are not useful with generally flat-bottomed containers.

Another problem is that only ice cream cones having approximately the same angle between the altitude and the side wall as that of the socket are firmly held. Ice cream cones having other angles are loosely held and subject to being jostled and damaged during handling and transporting.

Yet, none of the existing patents and prior arts serve as a full and comprehensive solution to problems stated.

It is the present invention's goal that enable an apparatus of a combined ice cream cup and connecting means, formed in a one part, that enabling a method that allows the connecting of such ice cream cups to each other, even as numerous ice cream cups, fitted to accommodate, for example one ice cream ball, hence has the appropriate size that fitted to one's hand even if more than one cup of the present invention is grasped.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

The present invention enables an apparatus of a combined ice cream cup, with an inner hollow section designated to accommodate the ice cream, and an un-detachable outer part at the cup body designated to serve as the connecting means, formed in a one part, that enabling a method that allows a user to connect polarity of such ice cream cups to each other, to one's needs.

The present invention relates to an apparatus of an ice cream cup embodying a hollow portion of a cup suitable to accommodate an ice cream material which has a connecting mean that enables to connect more cups of the same apparatus to the same cup, such cup enabling inserted and connecting or disconnecting one cup to at least one more cup, and a method that enable the connecting of multiple ice cream cups to each other, wherein, the present invention apparatus and method enabling to use separate different flavor of ice cream to each and every cup, instead of stacking ice cream balls on top of each other. Particularly, the present invention uses a special made handle to circumvent direct heat transfer through ice cream grasping by hands. This interconnecting ice cream cup system, with separated cups containing either the same or different flavors of ice cream, is formed in a technique that designated either as a handle or a cup, to form as a connector that fitted with another cup apparatus of the present invention, enabling the user to hold in one hand more than multiple cups of ice cream as in the present invention to allow tasting different flavors of ice cream and reduce ice cream melting through heat transfer by hands.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a schematic illustrating of the cup of the present invention shaped together with a connecting means that enabling the connecting and the disconnecting of such a cup to another cup of the present invention;

FIG. 2 another view of a schematic illustrating of the cup of the present invention shaped together with a connecting means that enabling the connecting and the disconnecting of such a cup to another cup of the present invention;

FIG. 3 is another view of a schematic illustrating of the cup of the present invention shaped together with a connecting means that enabling as seen in this schematic illustrating the connecting and the disconnecting of such a cup to another cup of the present invention;

FIG. 4 is another view of a schematic illustrating of the cup of the present invention shaped together with a connecting means that enabling as seen in this schematic illustrating the connecting and the disconnecting of such a cup to another cup of the present invention.

FIG. 5 is a plain view of a schematic illustrating of two cups of the present invention shaped together with a connecting means that enabling as seen in this schematic illustrating the connecting and the disconnecting of such a cup to another cup of the present invention

FIG. 6 is a plain view of a schematic illustrating of three cups of the present invention shaped together with a connecting means that enabling as seen in this schematic illustrating the connecting and the disconnecting of such a cup to another cups of the present invention

FIG. 7 is three dimensions plain view of a schematic illustrating of two cups of the present invention shaped together with a connecting means that enabling as seen in this schematic illustrating the connecting and the disconnecting of such a cup to another cup of the present invention

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

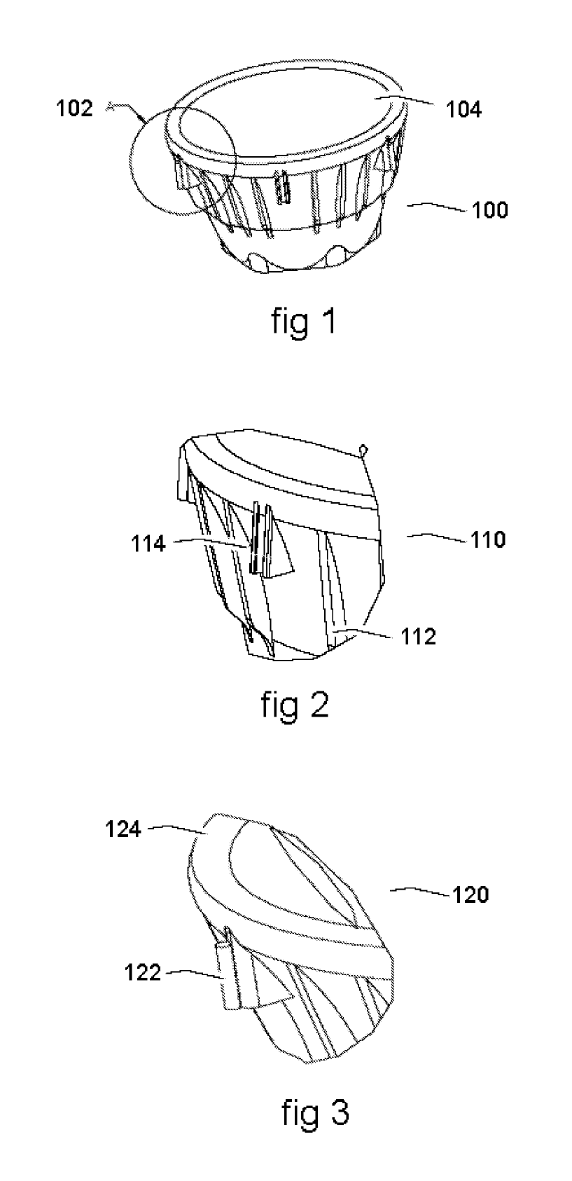

FIG. 1 is a schematic illustrating of the cup 100 of the present invention shaped together with a connecting means that enabling the connecting and the disconnecting of such a cup to another cup of the present invention, wherein a hollowed cup designated to accommodates in its inner hollowed portion 104 an ice cream, wherein the cup includes a un-detachable connecting means at the outer portion of the cup, and the method of the present invention enables to connect to such a cup at list one more same cup designated to accommodates ice cream in a way that enable the user to hold the connected cups in one hand, and to connect or to disconnect one cup or more from the connecting cups gathering cups apparatus.

FIG. 2 is another view of a schematic illustrating of the cup 110 of the present invention shaped together with a connecting means 114 that enabling the connecting and the disconnecting of such a cup to another cup of the present invention, wherein, a ribs 112 at the cup outer side enabling a better thermal condition, separation between the hand user grip and heat and the ice-cream temperature at the inner hollow zone.

FIG. 3 is another view of a schematic illustrating of the cup 120 of the present invention shaped together with a connecting means 122 that enabling as seen in this schematic illustrating the connecting and the disconnecting of such a cup to another cup as in the present invention by clicking male connector 122 to a female connector, as a one connecting means option, wherein, the cups border 124 enables the hollow space in the inner part of the cup 120 to enable the accommodation of the materials.

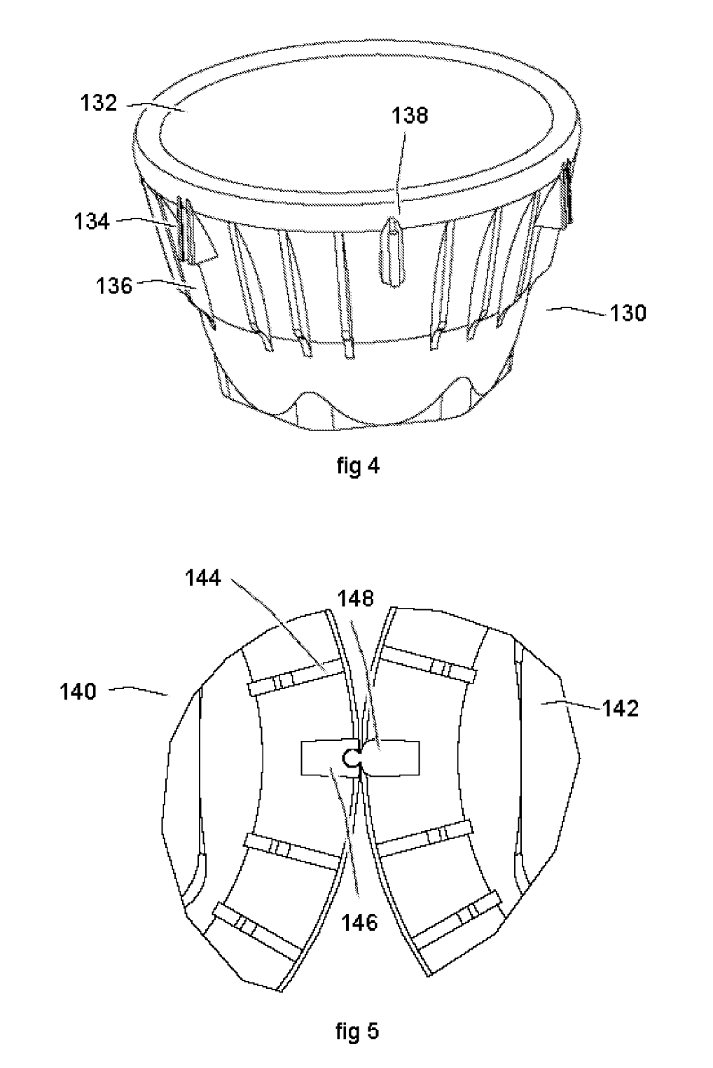

FIG. 4 is a plain view of a schematic illustrating of the cup 130 of the present invention shaped together with a connecting means that enabling as seen in this schematic illustrating the connecting and the disconnecting of such a cup to another cup of the present invention by clicking male connector 138 to a female connector 134 of another cup, as a one connecting means option, wherein, the cups border enables the hollow space 132 in the inner part of the cup 130 to enable the accommodation of the materials. wherein, the ribs 136, which can be another element such as a handle, at the cup outer side enabling a better thermal condition, separation between the hand user grip and heat and the ice-cream temperature at the inner hollow zone.

FIG. 5 is a plain view of a schematic illustrating of two cups 140 of the present invention shaped together with a connecting means that enabling as seen in this schematic illustrating the connecting and the disconnecting of such a cup to another cup of the present invention by clicking male connector 148 to a female connector 146 of another cup, as a one connecting means option, wherein, the ribs 144, which can be another element such as a handle, at the cup outer side 142 enabling a better thermal condition, separation between the hand user grip and heat and the ice-cream temperature at the inner hollow zone.

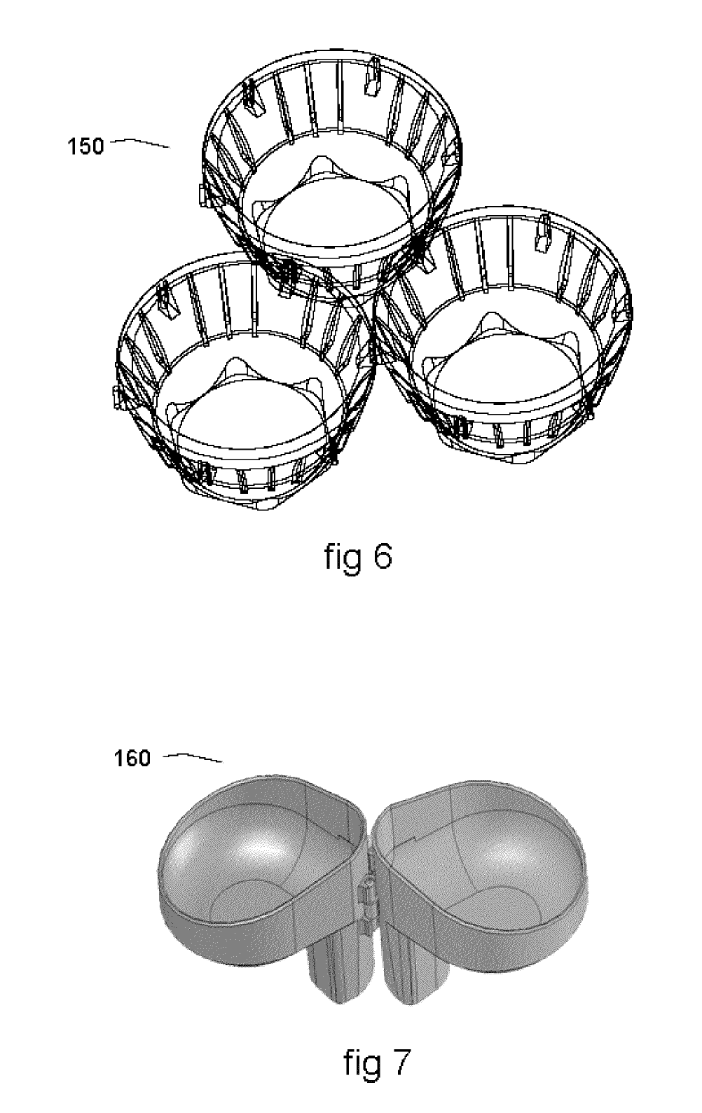

FIG. 6 is a plain view of a schematic illustrating of three cups 150 of the present invention shaped together with a connecting means that enabling as seen in this schematic illustrating the connecting and the disconnecting of such a cup to another cups of the present invention

FIG. 7 is three dimensions plain view of a schematic illustrating of two cups 160 of the present invention shaped together with a connecting means that enabling as seen in this schematic illustrating the connecting and the disconnecting of such a cup to another cup of the present invention

What is claimed is:

1. A hollowed cup designated to accommodate in its inner hollow portion an ice cream, wherein the cup includes a un-detachable connecting means at the outer portion of the cup, and a method that enables to connect to such a cup at least one more same cup designated to accommodates ice cream in a way that enable the user to hold the connected cups in one hand, and to connect or to disconnect one cup or more from the connecting cups gathering cups apparatus.

2. The method and apparatus of claim 1 wherein the connecting means that enables connecting and disconnecting of cups are made in manufacturing process together with the cup as a one pattern and piece of material that can not be separated.

3. The method and apparatus of claim 1 wherein the connecting means that enables connecting and disconnecting of cups are made in manufacturing process together with the cup as a one pattern and piece of plastic material that can not be separated, and optionally enable after connected a changing position of the cups to the sides.

4. The method and apparatus of claim 1 wherein the connecting means that enables connecting and disconnecting of cups are made in manufacturing process together with the cup as a one pattern and piece designated to be of a one time disposable apparatus.

5. The method and apparatus of claim 1 wherein the connecting means that enables connecting and disconnecting of cups are made in a way that enabling connecting of one cup to another by pressing one connecting means to another connecting means by pressuring hand force that pushes a getting higher and getting out part to a depression part of the connecting means.

6. The method and apparatus of claim 1 wherein the connecting means that enables connecting and disconnecting of cups are more than one connector in each cup to enable connecting options of more than two cups to each other to perform the apparatus in a vast and plurality optional amount of cups that the apparatus forms.

7. The method and apparatus of claim 1 wherein the connecting means that enables connecting and disconnecting of one cup are made in a way that enabling the placing of one connecting means onto another connecting means in a manner that one placing one disposable cup one another disposable cup.

8. The method and apparatus of claim 1 wherein the connecting means that are part of the cup of the present invention are more than one kind, and there are at least male and female connectors one each cup.

9. The method and apparatus of claim 1 wherein the cup of the present invention is in a shape of an ice cream cup.

10. The method and apparatus of claim 1 wherein the cup of the present invention includes a ribs, which can be another element such as a handle, at the cup outer side enabling a better thermal condition, separation between the hand user grip and heat and the ice-cream temperature at the inner hollow zone, and preventing the ice-cream from melting.

11. A method that enables hollowed cup designated to accommodates in its inner hollowed portion an ice cream, wherein the cup includes a un-detachable connecting means at the outer portion of the cup, and a method that enables to connect to such a cup at list one more same cup designated to accommodates ice cream in a way that enable the user to hold the connected cups in one hand, and to connect or to disconnect one cup or more from the connecting cups gathering cups apparatus.

12. A method to circumvent direct heat transfer through ice cream grasping by hands through a handle built in to the cup, or through the usage of an empty cup that connects to other cups of ice cream to prevent grasping of ice cream cups by its users.
